(19) United States
(12) Patent Application Publication
(10) Pub. No.: US 2026/0067547 A1
(43) Pub. Date: Mar. 5, 2026

(54) EYEBALL TRACKING OPTICAL SYSTEM AND HEAD-MOUNTED DEVICE

(71) Applicant: BEIJING 7INVENSUN TECHNOLOGY CO., LTD., Beijing (CN)

(72) Inventors: Juanjuan SHANG, Beijing (CN); Wenbo FEI, Beijing (CN)

(73) Assignee: BEIJING 7INVENSUN TECHNOLOGY CO., LTD., Beijing (CN)

(21) Appl. No.: 18/878,036

(22) PCT Filed: Jun. 20, 2023
(86) PCT No.: PCT/CN2023/101521

§ 371 Date: Nov. 4, 2025

(30) Foreign Application Priority Data
Jun. 21, 2022 (CN) 202210706708.3

(51) Int. Cl. H04N 23/20; G02B 27/01

(52) U.S. Cl. CPC H04N 23/20; G02B 27/0179; G02B 2027/0187

(57) ABSTRACT

Provided is an eyeball tracking optical system and a head-mounted device. The system includes a light source module, a fixed lens group module, a prism module and an image collection module. In a light path for shooting an image of eyes by external reflection of the image collection module, adding at least one reflection prism at the front end of a light-sensitive face of the image collection module.

### CROSS-REFERENCE TO RELATED APPLICATIONS

This application is a National Stage Entry under 35 U.S.C. § 371 of PCT International Application No. PCT/CN2023/101521, filed on Jun. 20, 2023, which claims priority to Chinese Patent Application No. 202210706708.3 filed on Jun. 21, 2022 and entitled “Eyeball Tracking Optical System and Head-Mounted Device”, the entire contents of each of which are incorporated herein by reference for all purposes.

### TECHNICAL FIELD

The present disclosure relates to the technical field of eyeball tracking, in particular to an eyeball tracking optical system and a head-mounted device.

### BACKGROUND

An eyeball tracking technology may be realized by an optical recording method. The principle of the optical recording method is that movement of eyes of a tested person is recorded by using an infrared camera, namely, an image of the eyes which may reflect movement of the eyes is acquired, and features of the eyes are extracted from the obtained image of the eyes to establish an estimation model of sight. The features of the eyes may include: a pupil location, a pupil shape, an iris location, an iris shape, an eyelid location, a canthus location, a facula location (or a purkinje image), and the like. The optical recording method includes a pupil-cornea reflection method. The principle of the pupil-cornea reflection method is that a near-infrared light source irradiates the eyes, the infrared camera shoots the eyes, and meanwhile, a reflection point, on the cornea, of the light source, namely, a facula is shot, so that an image of the eyes with the facula is acquired.

At present, Virtual Reality (VR) helmets tend to be developed and designed in a direction of being thin and foldable, so most of them will be developed into products based on compact display optical machines. FIG. 1 is a schematic structure diagram of an eyeball tracking optical system provided by the relevant art, as shown in FIG. 1, in a near-eye eyeball tracking device, a camera 11 adopts an external reflection shooting solution, light ray S0 emitted by a light source 12 is reflected by an eyeball 13, reflection light S0′ enters a camera 11 after being reflected by a reflector 14, and finally, an image of eyes is presented. FIG. 1 illustrates a light path for shooting an image of eyes by external reflection of a camera, in which the camera 11 is located outside all lenses of the near-eye eyeball tracking device, in order not to obstruct the field of view and not to interfere with other locations, the camera 11 is disposed at the edge of an optical lens and not too far from the optical lens, therefore, the shooting angle of the camera is sometimes very large, part of area of the eyes is blocked and cannot be collected, and consequently, the effective utilization rate of a light-sensitive face of the camera 11 is not high.

### SUMMARY

The present disclosure provides an eyeball tracking optical system and a head-mounted device, in a light path for shooting an image of eyes by external reflection of an image collection module, by adding at least one reflection prism at the front end of a light-sensitive face of the image collection module, the effects of reducing the size of the system, extending the light path and reducing a shooting angle of the image collection module may be achieved, the light-sensitive face of the image collection module is more effectively utilized, the shooting area of eyes is expanded, the problem of incomplete imaging due to the fact that part of area of the eyes is blocked is well solved, and the imaging quality of the image of eyes is improved.

The present disclosure provides an eyeball tracking optical system, which includes a light source module, a fixed lens group module, a prism module and an image collection module.

The light source module and the image collection module are both located at the edge of the side, close to the eyeball of a user, of the fixed lens group module, and the light source module is configured to transmit a light ray of a preset wavelength to the eyeball of the user; and the light ray of the preset wavelength form a reflection light ray after being reflected by the eyeball of the user.

The prism module includes at least one reflection prism, and at least one reflection prism is located at the front end of a light-sensitive face of the image collection module; and after being reflected by the fixed lens group module, the reflection light ray enters the image collection module after being reflected by the at least one reflection prism, and the image collection module is configured to generate an image of the eyeball of the user.

Optionally, a reflection face of the reflection prism is a plane.

Optionally, an included angle between the reflection face of the reflection prism and a plane where a light-sensitive face of the image collection module is located is α, and 0°<α<90°.

Optionally, a reflection face of the reflection prism is a concave face.

Optionally, a reflection face of the reflection prism includes a reflection-enhancing film; and the reflection-enhancing film is disposed to improve the reflection efficiency of the reflection light ray.

Optionally, at least one reflection prism and the image collection module are fixedly disposed.

Optionally, the size of the reflection prism meets 3 mm*3 mm*3 mm.

Optionally, the light source module includes an array infrared-band light source, which is configured to emit an array infrared-band light ray.

Optionally, the fixed lens group module includes a first fixed lens close to the eyeball of the user, and the first fixed lens includes an infrared-cut filter, which is configured to reflect reflection light ray to the prism module.

In a second aspect, the present disclosure further provides a head-mounted device, which includes a head-mounted apparatus and the eyeball tracking optical system above.

For the eyeball tracking optical system provided by the present disclosure, in the light path for shooting the image of eyes by external reflection of the image collection module, by adding at least one reflection prism at the front end of the light-sensitive face of the image collection module, the effects of reducing the size of the system, extending the light path and reducing the shooting angle of the image collection module may be achieved, the light-sensitive face of the image collection module is fully utilized, the shooting area of eyes is expanded, the problem of incomplete imaging due to the fact that part of area of the eyes is blocked is well solved, and the imaging quality of the image of eyes is improved.

### BRIEF DESCRIPTION OF THE DRAWINGS

FIG. 1 is a schematic structure diagram of an eyeball tracking optical system provided by the relevant art.

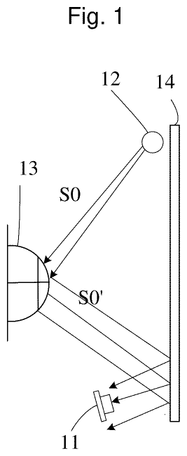

FIG. 2 is a schematic structure diagram of an eyeball tracking optical system provided by the present disclosure.

FIG. 3 is a schematic structure diagram of another eyeball tracking optical system provided by the present disclosure.

FIG. 4 is a schematic structure diagram of still another eyeball tracking optical system provided by the present disclosure.

FIG. 5 is a schematic structure diagram of yet another eyeball tracking optical system provided by the present disclosure.

### DETAILED DESCRIPTION OF THE EMBODIMENTS

The present disclosure is elaborated in detail below with reference to the drawings and embodiments. It can be understood that the specific embodiments described herein are for the purpose of illustrating the present disclosure, rather than limiting the present disclosure. In addition, it is further to be noted that, for ease of description, the drawings only illustrate part, rather than all structures related to the present disclosure.

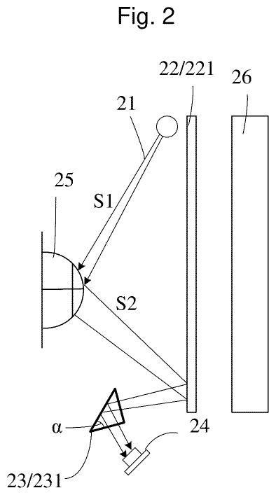

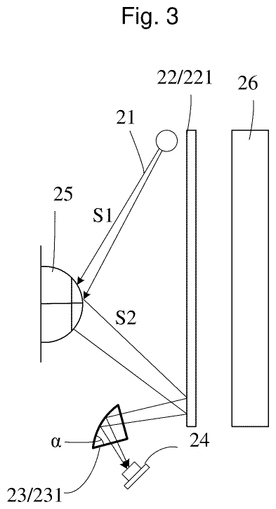

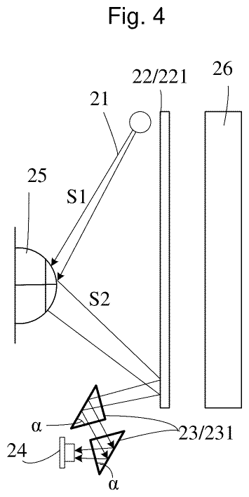

FIG. 2 is a schematic structure diagram of an eyeball tracking optical system provided by the present disclosure; FIG. 3 is a schematic structure diagram of another eyeball tracking optical system provided by the present disclosure; and FIG. 4 is a schematic structure diagram of still another eyeball tracking optical system provided by the present disclosure. As shown in FIGS. 2 and 4, for the eyeball tracking optical system provided by the present disclosure, the system includes a light source module 21, a fixed lens group module 22, a prism module 23 and an image collection module 24; the light source module 21 and the image collection module 24 are both located at the edge of the side, close to the eyeball 25 of a user, of the fixed lens group module 22, and the light source module 21 is configured to transmit a light ray of a preset wavelength to the eyeball 25 of the user; the light ray of a preset wavelength form a reflection light ray after being reflected by the eyeball 25 of the user; the prism module 23 includes at least one reflection prism 231, and at least one reflection prism 231 is located at the front end of a light-sensitive face of the image collection module 24; and after being reflected by the fixed lens group module 22, the reflection light ray enters the image collection module 24 after being reflected by the at least one reflection prism 231, and the image collection module 24 is configured to generate an image of the eyeball 25 of the user.

Specifically, the eyeball tracking optical system provided by the present disclosure further includes a mounting frame (not shown in the figure), as shown in FIGS. 2 and 4, the light source module 21, the fixed lens group module 22, the prism module 23 and the image collection module 24 are fixedly disposed in the mounting frame. The light source module 21 includes at least one light-emitting light source, which may emit light ray S1 of a present wavelength that may be received and reflected by eyes, such as a light ray of a visible light band and an infrared band; the fixed lens group module 22 includes a first fixed lens 221, the first fixed lens 221 is located on one side close to the eyeball 25 of the user, and the first fixed lens 221 may adopt a Fresnel lens to achieve the effects of protecting other assemblies and focusing light rays; and the image collection module 24 includes at least one image collection device, such as a camera, which is configured to receive the reflection light ray and generate an image of the eyeball. The light source module 21 and the image collection module 24 are located at the edge of a side, close to the eyeball 25 of the user, of the fixed lens group module 22, and the light source module 21 and the image collection module 24 may be located on the same side or different sides of the eyeball 25 of the user. The prism module 23 includes at least one reflection prism 231, and the reflection prism 231 has a reflection face. The reflection prism 231 utilizes the law of reflection and the law of refraction of light, and when light is reflected in a same medium, its reflection angle and incidence angle are equal; and when light is incident from one medium to another medium perpendicular to two medium planes, no refraction occurs. FIG. 2 and FIG. 3 illustrate that one reflection prism 231 is located at the front end of a light-sensitive face of the image collection module 24, light rays emitted by the light source module 21 form reflection light rays after being reflected by the eyeball 25 of the user, and after being reflected by the fixed lens group module 22, the reflection light rays are received by the light-sensitive face of the image collection module 24 after being reflected by the reflection face of one reflection prism 231. FIG. 4 illustrates that two reflection prisms 231 are located at the front end of the light-sensitive face of the image collection module 24, light rays emitted by the light source module 21 form reflection light rays after being reflected by the eyeball 25 of the user, after being reflected by the fixed lens group module 22, the reflection light rays are received by the light-sensitive face of the image collection module 24 after being sequentially reflected by the reflection face of two combined reflection prisms 231, and the image collection module 24 generates an image of the eyeball 25 of the user. In the light path for shooting the image of eyes by external reflection of the image collection module 24, by adding at least one reflection prism 231 at the front end of the light-sensitive face of the image collection module 24, the effects of extending the light path and reducing the shooting angle may be achieved, the light-sensitive face of the camera is fully utilized, the shooting area of eyes is expanded, the problem of incomplete imaging due to the fact that part of area of the eyes is blocked is well solved, and the imaging quality of the image of eyes is improved. Meanwhile, by adding the reflection prism 231, the location of the image collection module 24 may be flexibly set, which is beneficial for compressing the size of the eyeball tracking optical system.

To sum up, for the eyeball tracking optical system provided by the present disclosure, in the light path for shooting the image of eyes by external reflection of the camera, by adding at least one reflection prism 231 at the front end of the light-sensitive face of the camera, the effects of reducing the size of the system, extending the light path and reducing the shooting angle of the camera may be achieved, the shooting area of eyes is expanded, the problem of incomplete imaging due to the fact that part of area of the eyes is blocked is well solved, and the imaging quality of the image of eyes is improved.

As a feasible implementation mode, with a further reference to FIG. 2, optionally, a reflection face of the reflection prism 231 is a plane. By adopting the plane reflection face, the propagation direction of the reflection light rays S2 is changed, the effects of extending the light path and reducing the shooting angle of the camera are achieved, so that the image of eyes collected by the image collection module 24 is more complete, and the requirement for image processing by algorithm is better met.

As a feasible implementation mode, with a further reference to FIG. 3, optionally, a reflection face of the reflection prism 231 is a concave face. By setting the reflection face of the reflection prism 231 as a concave face, reflection light rays S2 may be focused, so that the light-sensitive face of the image collection module 24 may receive more reflection light rays S2, and the brightness of eye imaging and integrity of eye imaging are improved.

On the basis of the abovementioned embodiment, as shown in FIGS. 2-4, optionally, an included angle between the reflection face of the reflection prism 231 and a plane where the light-sensitive face of the image collection module 24 is located is α, and 0°<α<90°.

Specifically, the reflection face of the reflection prism 231 may be a plane or a concave face, and an included angle a between the reflection face of the reflection prism 231 and a plane where the light-sensitive face of the image collection module 24 is located is an acute angle. When the reflection face of the reflection prism 231 is a plane, preferably, α=45°, by adjusting the included angle a between the reflection face of the reflection prism 231 and a plane where the light-sensitive face of the image collection module 24 is located, the propagation direction of the reflection light rays S2 is changed, the location of the image collection module 24 may be flexibly set, while blocking of line of sight and interference are avoided, the complete image of eyes may be collected.

Optionally, with reference to FIGS. 2-4, the size of the reflection prism 231 meets 3 mm*3 mm*3 mm.

By adopting the small-size reflection prism 231 to adjust the propagation direction of the reflection light rays S2, the space proportion is small, the position is flexible and changeable, and the size structure of the whole system is not influenced, which is beneficial for size compression of the eyeball tracking optical system.

Optionally, the reflection face of the reflection prism 231 includes a reflection-enhancing film; and the reflection-enhancing film is disposed to improve the reflection efficiency of the reflection light ray. By additionally plating the reflection-enhancing film on the reflection face of the reflection prism 231, the reflection-enhancing film includes a full-band reflection film, which may improve the reflection efficiency of the reflection light rays S2, so that more reflection light rays S2 enter the image collection module 24, and the brightness of the image of eyes is improved.

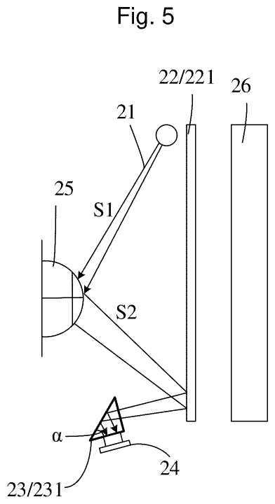

FIG. 5 is a schematic structure diagram of yet another eyeball tracking optical system provided by the present disclosure. Optionally, as shown in FIG. 5, at least one reflection prism 231 and the image collection module 24 are fixedly disposed.

Specifically, by fixing disposing front ends of the reflection prism 231 and the image collection module 24, the reflection prism 231 may tightly attach to the light-sensitive face of the image collection module 24, then position movement of the reflection face of the reflection prism 231 and the light-sensitive face of the image collection module 24 is reduced, shake is reduced, and the stability of the image collection module 24 for eye imaging is ensured.

Optionally, with reference to FIGS. 2-4, the reflection prism 231 may also have a certain distance with the light-sensitive face of the image collection module 24, so as to achieve the purpose of flexibly adjusting the location of the image collection module 24.

On the basis of the abovementioned embodiment, with a further reference to FIGS. 2 and 3, optionally, the light source module 21 includes an array infrared-band light source, which is configured to emit an array infrared-band light ray.

Specifically, the array infrared-band light source is an array group composed of a plurality of infrared light-emitting sources (700 nm-1100 nm or a specific band), which emits array infrared-band light rays. By adopting the array infrared-band light source, the area around eyes of the user may be uniformly illuminated, and a facula with a constraint property is formed on the iris of the eyeball of the user. Meanwhile, the brightness of the image of the eyes collected by the image collection module 24 is more uniform, which is beneficial for subsequent work.

On the basis of the abovementioned embodiment, with a further reference to FIGS. 2 and 4, optionally, the fixed lens group module 22 includes a first fixed lens 221 close to the eyeball 25 of the user, and the first fixed lens 221 includes an infrared-cut filter, which is configured to reflect the infrared-band light rays emitted by the array infrared-band light source to the prism module 23. The infrared-cut filter refers to a lens through which light rays of an infrared band are reflected and light rays of other wavelengths transmit, optical films with high refractive index and low refractive index are alternately plated on optical glass by using a precise optical film plating technology, an optical light filter realizing infrared (700 nm-1100 nm) cut-off is formed, the first fixed lens 221 adopts the infrared-cut filter, so that more light rays emitted by the array infrared-band light source are reflected to the image collection module 24, and the utilization rate of light rays is improved.

On the basis of the abovementioned embodiment, with a further reference to FIGS. 2 and 3, optionally, the eyeball tracking optical system includes a display screen 26; and the display screen 26 is located on the side, away from the eyeball 25 of the user, of the fixed lens group module 22, and the display screen 26 is a multi-dimensional display screen 26, which is disposed to display a multi-dimensional image.

Specifically, the display screen 26 may be an Organic Light Emitting Diode (OLED) Display, an LED Display, a Micro LED Display, and the like, and displays a colored or white-black picture; and the display screen 26 is disposed to be located on the side, away from the eyeball 25 of the user, of the fixed lens group module 22, and the multi-dimensional image emitted by the display screen 26 reaches the eyes of the user for imaging after passing through the fixed lens group module 22.

Based on the same inventive concept, the present disclosure provides a head-mounted device, which includes a head-mounted apparatus and the eyeball tracking optical system provided by the above embodiment, and may be applied to wearable eyeball tracking and iris recognition of a user.

It is to be noted that the foregoing is only preferred embodiments of the present disclosure and technical principles used. Those skilled in the art will appreciate that the present disclosure is not limited to specific embodiments discussed herein, and may perform various obvious changes, rearrangements, combinations and substitutions without departing from the scope of the present disclosure. Therefore, although the present disclosure has been described in detail with reference to the above embodiments, the present disclosure is not limited to the above embodiments, and may include more other equivalent embodiments without departing from the conception of the present disclosure, and the scope of the present disclosure is determined by the scope of the appended claims.

1. An eyeball tracking optical system, comprising a light source module, a fixed lens group module, a prism module and an image collection module;
the light source module and the image collection module are both located at an edge of a side, close to an eyeball of a user, of the fixed lens group module, and the light source module is configured to transmit a light ray of a preset wavelength to the eyeball of the user; the light ray of the preset wavelength form a reflection light ray after being reflected by the eyeball of the user;
the prism module comprises at least one reflection prism, and at least one reflection prism is located at a front end of a light-sensitive face of the image collection module; after being reflected by the fixed lens group module, the reflection light ray enters the image collection module after being reflected by the at least one reflection prism, and the image collection module is configured to generate an image of the eyeball of the user.

2. The eyeball tracking optical system according to claim 1, wherein a reflection face of the reflection prism is a plane.

3. The eyeball tracking optical system according to claim 1, wherein an included angle between the reflection face of the reflection prism and a plane where a light-sensitive face of the image collection module is located is α, and 0°<α<90°.

4. The eyeball tracking optical system according to claim 1, wherein a reflection face of the reflection prism is a concave face.

5. The eyeball tracking optical system according to claim 1, wherein a reflection face of the reflection prism comprises a reflection-enhancing film; and the reflection-enhancing film is disposed to improve a reflection efficiency of the reflection light ray.

6. The eyeball tracking optical system according to claim 1, wherein at least one reflection prism and the image collection module are fixedly disposed.

7. The eyeball tracking optical system according to claim 1, wherein a size of the reflection prism meets 3 mm*3 mm*3 mm.

8. The eyeball tracking optical system according to claim 1, wherein the light source module comprises an array infrared-band light source, which is configured to emit an array infrared-band light ray.

9. The eyeball tracking optical system according to claim 1, wherein the fixed lens group module comprises a first fixed lens close to the eyeball of the user, and the first fixed lens comprises an infrared-cut filter, which is configured to reflect the reflection light ray to the prism module.

10. A head-mounted device, comprising a head-mounted apparatus and the eyeball tracking optical system according claim 1.

11. The head-mounted device according to claim 10, wherein a reflection face of the reflection prism is a plane.

12. The head-mounted device according to claim 10, wherein an included angle between the reflection face of the reflection prism and a plane where a light-sensitive face of the image collection module is located is α, and 0°<α<90°.

13. The head-mounted device according to claim 10, wherein a reflection face of the reflection prism is a concave face.

14. The head-mounted device according to claim 10, wherein a reflection face of the reflection prism comprises a reflection-enhancing film; and the reflection-enhancing film is disposed to improve a reflection efficiency of the reflection light ray.

15. The head-mounted device according to claim 10, wherein at least one reflection prism and the image collection module are fixedly disposed.

16. The head-mounted device according to claim 10, wherein a size of the reflection prism meets 3 mm*3 mm*3 mm.

17. The head-mounted device according to claim 10, wherein the light source module comprises an array infrared-band light source, which is configured to emit an array infrared-band light ray.

18. The head-mounted device according to claim 10, wherein the fixed lens group module comprises a first fixed lens close to the eyeball of the user, and the first fixed lens comprises an infrared-cut filter, which is configured to reflect the reflection light ray to the prism module.

19. The head-mounted device according to claim 10, wherein the eyeball tracking optical system further comprising a mounting frame, the light source module, the fixed lens group module, the prism module and the image collection module are fixedly disposed in the mounting frame.

20. The head-mounted device according to claim 10, wherein the eyeball tracking optical system further comprising a display screen, the display screen is located on a side, away from the eyeball of the user, of the fixed lens group module, and the display screen is a multi-dimensional display screen, which is disposed to display a multi-dimensional image.
